(19) United States
(12) Patent Application Publication
(10) Pub. No.: US 2006/0199607 A1
(43) Pub. Date: Sep. 7, 2006

(54) MOBILE PHONE WITH A SLIDABLE KEYBOARD

(76) Inventors: Xiao-Xi Shi, Shenzhen (CN); Ho-An Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/306,637

(22) Filed: Jan. 5, 2006

(30) Foreign Application Priority Data
Jan. 29, 2005 (CN) 200520054536.8

(51) Int. Cl. H04M 1/00

(52) U.S. Cl. 455/550.1

(57) ABSTRACT

A mobile phone includes a phone body (10), and a keyboard (20) slidably arranged on and electrically connecting with the phone body. The phone body has a top surface (11), two lateral surfaces (12), a display screen (13), and a keypad (14) disposed on the top surface. At least one lateral surface has an elongated guide groove (15) defined therein. The keyboard has a top plate (21), a pair of side plates (22), and a plurality of keys (23) disposed on the top plate. At least one side plate has a guide rail (25) protruding on an inner wall thereof. The guide rail corresponds to and slidably engages with the guide groove. The keyboard is slidable between a first position and a second position on two opposite side of the display screen.

### FIELD OF THE INVENTION

The present invention relates generally to portable electronic devices, and particularly to a mobile phone with a slidable keyboard.

### DESCRIPTION OF RELATED ART

As mobile phone technology advances, various software applications, such as on-line gaming software, are being incorporated into them. In fact, on-line gaming software is now considered by some to be the most popular and indispensable features available for mobile phones. Network game development companies are continually introducing various new on-line network games in prolific quantities, and these network games now occupy a significant market position. In addition, the plethora of available on-line games is attracting an increasing number of users.

Accordingly, more and more mobile telephones are equipped with game playing functions. Many currently available mobile phones have pre-installed game software, and are capable of downloading new games from the Internet.

Generally, when using ordinary bar phones, which has a keypad arranged adjacent a display screen thereof, a user uses one hand to hold the phone and uses the thumb of the hand to operate the keypad when he/she plays games equipped in the bar phone or inputs information into the bar phone. However, it is inconvenient to hold and operate the bar phone with one hand. Furthermore, there is a risk the user may drop the phone when using only one hand to operate it.

To solve the above-described problems, Nokia Corporation produces a game mobile telephone known as N-Gage. The shape of N-Gage is substantially quadrate. A screen is arranged in a middle of a main body of the mobile telephone, with a keypad arranged at each of two sides of the screen. However, the size of the mobile telephone is unduly large. In addition, it can be uncomfortable to hold when phoning.

As another example in the art, Sony Ericsson Corporation provides a game mobile telephone marketed under the model number Z608. The Z608 has a complementary game board for playing games. When a user wants to play games, it is necessary to connect the game board to the mobile telephone via a connector. However, the game board is inconvenient to carry. In addition, repeated connection and disconnection of the connector may eventually damage the connector and adversely affect or prevent game play.

What is needed, therefore, is an improved mobile phone with which games can be conveniently played.

### SUMMARY OF THE INVENTION

In a preferred embodiment, a mobile phone includes a phone body, and a keyboard slidably arranged on and electrically connecting with the phone body. The phone body has a top surface, two lateral surfaces opposite to each other and connecting with the top surface, and a display screen and a keypad disposed on the top surface. At least one lateral surface has an elongated guide groove defined therein. The keyboard has a top plate, a pair of side plates perpendicularly bent from two opposite end of the top plate, a plurality of keys disposed on the top plate. At least one side plate has a guide rail protruding on an inner wall thereof. The guide rail corresponds to and slidably engages with the guide groove of the phone body. The keyboard is slidable at a first position and a second position on two opposite sides of the display screen.

Other advantages and novel features will become more apparent from the following detailed description of preferred embodiments when taken in conjunction with the accompanying drawings.

### BRIEF DESCRIPTION OF DRAWINGS

Many aspects of a mobile phone with a slidable keyboard can be better understood with reference to the following drawings. The components in the drawings are not necessarily to scale, the emphasis instead being placed upon clearly illustrating the principles of the mobile phone with a slidable keyboard. Moreover, in the drawings, like reference numerals designate corresponding parts throughout the several views.

FIG. 1 is a schematic, disassembled perspective view of a mobile phone with a slidable keyboard according to one embodiment of the present invention;

FIG. 2 is an assembled perspective view of FIG. 1, showing the slidable keyboard engaged at a first position; and

FIG. 3 is an assembled perspective view of FIG. 1, showing the slidable keyboard engaged at a second position.

### DETAILED DESCRIPTION

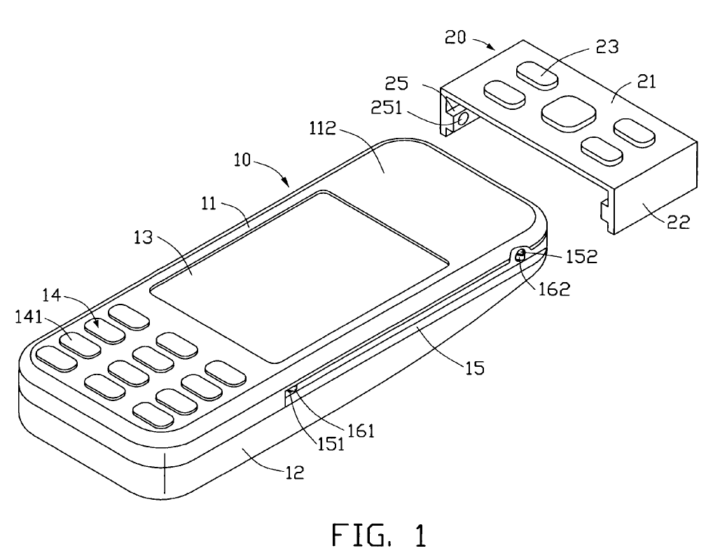

As shown in FIG. 1, a mobile phone with a slidable keyboard according to one embodiment of the present invention, includes a phone body 10, and a keyboard 20, which is attached to the phone body 10. The keyboard 20 can slide in forward and backward directions and electrically connects with the phone body 10.

The phone body 10 includes a circuit board (not shown) received therein, a top surface 11, and two lateral surfaces 12 opposite to each other and both connecting with the top surface 11. A display screen 13 is disposed at a middle portion of the top surface 11. A keypad 14, including a plurality of key buttons 141, which can for example be numerical key buttons, is disposed at a distal portion of the top surface 11, adjacent to the display screen 13 and opposite to a margin portion 112. The two lateral surfaces 12 are each formed with a guide groove 15 extending longitudinally. Each guide groove 15 begins with a position corresponding to the margin portion 112, and extends to another position corresponding to an end of the display screen 13 adjacent the keypad 14. Each lateral surface 12 has a first hole 151 and a second hole 152 respectively defined near opposite ends of the guide groove 15. A first elastic pin 161 telescopically protrudes from each first hole 151, and a second elastic pin 162 telescopically protrudes from each second hole 152. The first and second elastic pins 161, 162 electrically connect with the printed circuit board of the phone body 10.

The keyboard 20 includes a top plate 21 and a pair of side plates 22 bent perpendicularly from two opposite sides of the top plate 21. A plurality of keys 23, such as function keys and direction keys, protrude from the top plate 21. A guide rail 25 protrudes inwardly from an inner wall of each of the side plates 22. Each guide rail 25 has a recess 251 defined therein in order for engaging with the elastic pins 161, 162. A surface of each recess 251 is coated with metal plate that is electrically connected with the keys 23 by a circuit internally defined in the keyboard 20.

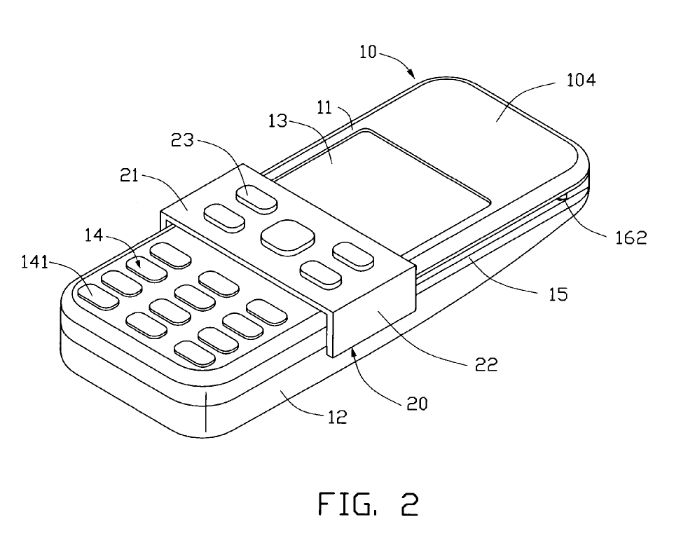

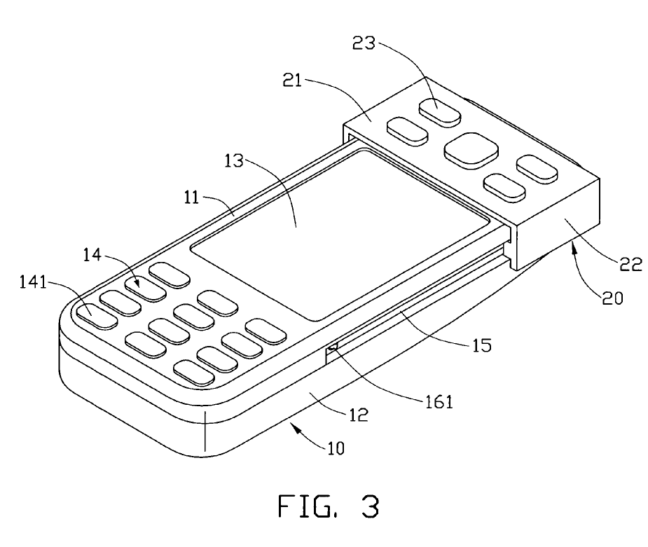

As shown in FIGS. 2 and 3, in assembly, the keyboard 20 is slidably arranged on the phone body 10 by the guide rails 25 respectively slidably received in the guide grooves 15. The keyboard 20 moves between a first position (see FIG. 2) and a second position (see FIG. 3). At the first position, the first elastic pins 161 are each engaged with a respective recess 251, in this position the keyboard 20 is near the keypad 14 and covers part of the display screen 13. At the second position, the second pins 162 are each engaged with a respective recess 251, in this position the keyboard 20 is at the margin portion 112 of the phone body 10. At each position, the metal plates of the recesses 251 of the keyboard 20 electrically connect with the elastic pins 161 or 162 of the phone body 10.

In ordinary use, the keyboard 20 is placed at the first position, and the usage of the mobile phone is similar to that of an ordinary bar phone. Since the display screen 13 is partially covered by the keyboard 20, all the information will automatically be displayed on the uncovered portion of the display screen 13. If a game is to be played or information is to be input, the keyboard 20 is slid by a user to the second position. Thus, the connections between the recesses 251 of the keyboard 20 with the first elastic pins 161 of the phone body 10 are released and the recesses 251 of the keyboard 20 engage with the second elastic pins 162. In the second position, the keypad 14 and the keyboard 20 are arranged on two sides of the display screen 13, thus it is convenient for the user to transversely hold the mobile phone and operate the keypad 14 and the keyboard 20 with two hands when performing activities such as playing games or inputting information. Accordingly, the image on the display screen 13 will rotate automatically for easy viewing when the mobile phone is transversely held by the user. Therefore, the mobile phone is easier to operate and easier to hold securely.

In further and/or other embodiments, after arranging the keyboard 20 on the phone body 10, the ends of each slide groove 15 at the distal ends of the lateral surfaces 12 may be blocked in order to prevent the keyboard 20 from sliding off the phone body 10.

In still further embodiments, the numeral keys 141 of the keypad 14 can instead be function keys and the direction keys and the keys 23 of the keyboard 20 can instead be numeral keys.

The present invention can be utilized for other portable electronic devices such as PDAs (Personal Digital Assistants) and palm computers etc.

It is believed that the present embodiments and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A mobile phone, comprising:
a phone body having a top surface, two lateral surfaces opposite to each other and connecting with the top surface, a display screen and a keypad disposed on the top surface, at least one lateral surface having an elongated guide groove defined therein; and
a keyboard slidably arranged on and electrically connecting with the phone body, the keyboard having a top plate, a pair of side plates perpendicularly bent from two opposite ends of the top plate, a plurality of keys disposed on the top plate, at least one side plate having a guide rail protruding thereon, the guide rail slidably engaged with the guide groove of the phone body, the keyboard being slidable between a first position and a second position at two opposite sides of the display screen.

2. The mobile phone as claimed in claim 1, wherein the display screen is located at a middle portion of the phone body, and one of the first and second positions corresponds to a portion of the phone body adjacent the display screen opposite to the keypad.

3. The mobile phone as claimed in claim 2, wherein the guide groove begins at a position corresponding to an end of the display screen adjacent the keypad and extends to another position corresponding to the portion opposite the keypad.

4. The mobile phone as claimed in claim 3, wherein the lateral surface, having the guide groove defined therein, has two holes respectively defined at opposite ends of the guide groove.

5. The mobile phone as claimed in claim 4, wherein the phone body has a pair of pins respectively telescopically passing through and protruding from a corresponding hole of the guide groove, and the pins electrically connect with a circuit board received in the phone body.

6. The mobile phone as claimed in claim 5, wherein the guide rail of the keyboard has a recess engageably corresponding to the pins of the phone body, and the recess is coated with a metal plate electrically that is connected with the keys of the keyboard by an internal circuit formed therein.

7. The mobile phone as claimed in claim 1, wherein when the keyboard is in one of the first and second positions a bottom of an image displayed on the display screen is adjacent the keypad, and when the keyboard is in the other of the first and second positions a side of an image displayed on the display screen is adjacent the keypad.

8. A portable electronic device comprising:
a main body having a top surface whereon a display screen and a keypad are positioned adjacent to each other; and
a keyboard having a plurality of keys located thereon, the keyboard slidably arranged on and electrically connecting with the main body, above the top surface, the keyboard being slidable between a first position adjacent the keypad and a second position on a side of the display screen opposite to the keypad.

9. The portable electronic device as claimed in claim 8, wherein the main body has two lateral surfaces and at least one guide groove, the guide groove is defined on one of the lateral surfaces and elongates from an end of the lateral surface away from the keypad to a position corresponding to an end of the display screen adjacent the keypad.

10. The portable electronic device as claimed in claim 9, wherein the lateral surface, having the guide groove defined therein, has two holes respectively defined near opposite ends of the guide groove.

11. The portable electronic device as claimed in claim 10, wherein the main body has a pair of pins telescopically respectively passing through and protruding from a corresponding hole of the guide groove, and the pins electrically connect with a circuit board of the main body.

12. The portable electronic device as claimed in claim 11, wherein the keyboard has a top plate, a pair of side plates perpendicularly bent from two opposite side of the top plate, a plurality of keys disposed on the top plate and at least one guide rail respectively protruding on an inner wall of the side plates, the guide rail corresponds to and slidably engages with the guide groove of the main body.

13. The portable electronic device as claimed in claim 12, wherein each guide rail of the keyboard has a recess engageably corresponding to the pins of the main body, and the recess is coated with a metal plate electrically connecting with the keys of the keyboard by a circuit internally formed therein.

14. The portable electronic device as claimed in claim 12, wherein when the keyboard is in one of the first and second positions a bottom of an image displayed on the display screen is adjacent the keypad, and when the keyboard is in the other of the first and second positions a side of an image displayed on the display screen is adjacent the keypad.

15. A portable electronic device comprising:
a main body having a top surface at which a display screen and a keypad being positioned adjacent to each other; and
a keyboard slidably arranged on the top surface of the main body.

16. The portable electronic device as claimed in claim 15, wherein the keypad of the main body includes a plurality of numeral keys, and the keyboard includes one of a function key and a direction key.

17. The portable electronic device as claimed in claim 15, wherein the keypad of the main body includes one of a function key and a direction key, and the keyboard includes a plurality of numeral keys.

18. The portable electronic device as claimed in claim 15, wherein the keyboard is arranged on the main boy via a moveable engagement between at least one guide groove defined in the main body and a corresponding guide rail disposed at the keyboard.

19. The portable electronic device as claimed in claim 18, wherein the main body has at least one pin telescopically respectively passing through and protruding from the guide groove, and the pin electrically connects with a circuit board of the main body, the guide rail has a recess engageably corresponding to the pin of the main body, and the recess is coated with a metal plate electrically connecting with the keys of the keyboard by a circuit internally formed therein.

20. The portable electronic device as claimed in claim 18, wherein the main body has a pair of lateral surfaces in which the guide groove is defined therein, the guide groove extends from an end of the lateral surface away from the keypad to a position corresponding to an end of the display screen adjacent the keypad.
